(19) United States
(12) Patent Application Publication
(10) Pub. No.: US 2024/0089995 A1
(43) Pub. Date: Mar. 14, 2024

(54) REALLOCATION OF UPLINK TRANSMISSION SLOTS BETWEEN WIRELESS NODES FOR RETRANSMISSION OF DATA WITHIN MEDICAL BODY AREA NETWORK

(71) Applicant: GE Precision Healthcare LLC, Wauwatosa, WI (US)

(72) Inventor: Timo Hakala, Helsinki (FI)

(21) Appl. No.: 17/932,115

(22) Filed: Sep. 14, 2022

(51) Int. Cl. H04W 72/04; H04L 1/08

(52) U.S. Cl. CPC H04W 72/0433; H04L 1/08; H04W 72/0446

(57) ABSTRACT

A method includes allocating, by a controller to each of a plurality of wireless nodes, at least one initial slot for transmission of new data in a first frame and at least one retransmission slot for retransmission of data in one or more subsequent frames, including allocating to a second wireless node at least a first retransmission slot for data retransmission in one or more frames subsequent to a first frame; determining that there is a failed data transmission from a first wireless node during a first frame; determining that the second wireless node does not need the at least the first retransmission slot; and transmitting a retransmission slot allocation message including information indicating that the at least the first retransmission slot has been allocated to the first wireless node for at least one frame subsequent to the first frame.

### TECHNICAL FIELD

This description relates to wireless communications, such as for monitoring of patients within a medical body area network.

### BACKGROUND

A medical body area network (MBAN) may replace wired sensors that monitor a patient with wireless sensors. Each sensor may measure or monitor one or more patient conditions or physiological measurements, such as blood pressure, heart rate, blood glucose level, pulse, or other clinical patient data or patient measurements. A wireless node may be provided or connected to each of the sensors to allow the clinical patient data measured by each sensor to be wirelessly communicated to a hub (which may also be referred to as a controller, a central controller, or a gateway).

MBAN clinical patient data may range from important patient data (e.g., a heart rate of a healthy patient undergoing a stress test), to critical patient data (e.g., such as clinical patient data for a critically ill patient in intensive care). For patient safety and MBAN performance, it may be desirable for clinical patient data be transmitted (delivered) to the hub with low latency and high reliability. For example, data that is not delivered to the hub, or data that is delivered late may create serious safety issues for the patient. Unfortunately, there may be many sources of radio interference within a hospital or clinic that may interfere with transmission of clinical patient data from a wireless node to the hub or controller, e.g., which may result in failed data transmissions (data that is transmitted by a wireless node but is not received by the hub or controller).

### SUMMARY

According to an example embodiment, a method may include allocating, by a controller within a wireless network for a first frame, slots to a plurality of wireless nodes within a wireless network, wherein each of the plurality of wireless nodes has one or more allocated slots for transmission or retransmission of data at least for the first frame, and wherein each frame includes a plurality of slots; determining, by the controller based on data transmissions performed during the first frame, that there is a failed data transmission from a first wireless node to the controller via at least one slot of a first set of one or more slots that were allocated to the first wireless node; determining, by the controller based on data transmissions performed during the first frame, that data was received by the controller from a second wireless node via at least one slot of a second set of one or more slots allocated to the second wireless node; and transmitting, by the controller to a plurality of wireless nodes including at least the first wireless node and the second wireless node, a message including slot allocation or reallocation information for the second frame, including information indicating that the at least one slot of the second set of one or more slots, which were allocated to the second wireless node, has been reallocated to the first wireless node to enable the first wireless node to retransmit to the controller, during the second frame, data for which there was a failed data transmission during the first frame, via the reallocated at least one slot.

According to an example embodiment, an apparatus may include means for allocating, by a controller within a wireless network for a first frame, slots to a plurality of wireless nodes within a wireless network, wherein each of the plurality of wireless nodes has one or more allocated slots for transmission or retransmission of data at least for the first frame, and wherein each frame includes a plurality of slots; means for determining, by the controller based on data transmissions performed during the first frame, that there is a failed data transmission from a first wireless node to the controller via at least one slot of a first set of one or more slots that were allocated to the first wireless node; means for determining, by the controller based on data transmissions performed during the first frame, that data was received by the controller from a second wireless node via at least one slot of a second set of one or more slots allocated to the second wireless node; and means for transmitting, by the controller to a plurality of wireless nodes including at least the first wireless node and the second wireless node, a message including slot allocation or reallocation information for the second frame, including information indicating that the at least one slot of the second set of one or more slots, which were allocated to the second wireless node, has been reallocated to the first wireless node to enable the first wireless node to retransmit to the controller, during the second frame, data for which there was a failed data transmission during the first frame, via the reallocated at least one slot.

According to an example embodiment, an apparatus may include: at least one processor; and at least one memory including computer program code; the at least one memory and the computer program code configured to, with the at least one processor, cause the apparatus at least to: allocate, by a controller within a wireless network for a first frame, slots to a plurality of wireless nodes within a wireless network, wherein each of the plurality of wireless nodes has one or more allocated slots for transmission or retransmission of data at least for the first frame, and wherein each frame includes a plurality of slots; determine, by the controller based on data transmissions performed during the first frame, that there is a failed data transmission from a first wireless node to the controller via at least one slot of a first set of one or more slots that were allocated to the first wireless node; determine, by the controller based on data transmissions performed during the first frame, that data was received by the controller from a second wireless node via at least one slot of a second set of one or more slots allocated to the second wireless node; and transmit, by the controller to a plurality of wireless nodes including at least the first wireless node and the second wireless node, a message including slot allocation or reallocation information for the second frame, including information indicating that the at least one slot of the second set of one or more slots, which were allocated to the second wireless node, has been reallocated to the first wireless node to enable the first wireless node to retransmit to the controller, during the second frame, data for which there was a failed data transmission during the first frame, via the reallocated at least one slot.

According to an example embodiment, a non-transitory computer-readable storage medium may include instructions stored thereon that, when executed by at least one processor, are configured to cause a computing system to allocate, by a controller within a wireless network for a first frame, slots to a plurality of wireless nodes within a wireless network, wherein each of the plurality of wireless nodes has one or more allocated slots for transmission or retransmission of data at least for the first frame, and wherein each frame includes a plurality of slots; determine, by the controller based on data transmissions performed during the first frame, that there is a failed data transmission from a first wireless node to the controller via at least one slot of a first set of one or more slots that were allocated to the first wireless node; determine, by the controller based on data transmissions performed during the first frame, that data was received by the controller from a second wireless node via at least one slot of a second set of one or more slots allocated to the second wireless node; and transmit, by the controller to a plurality of wireless nodes including at least the first wireless node and the second wireless node, a message including slot allocation or reallocation information for the second frame, including information indicating that the at least one slot of the second set of one or more slots, which were allocated to the second wireless node, has been reallocated to the first wireless node to enable the first wireless node to retransmit to the controller, during the second frame, data for which there was a failed data transmission during the first frame, via the reallocated at least one slot.

According to an example embodiment, a method may include receiving, by a first wireless node from a controller within a wireless network, an allocation of a first set of one or more slots for transmission or retransmission of data at least for a first frame, and wherein each frame includes a plurality of slots; transmitting, by the first wireless node to the controller, a packet via each of the slots of the first set of one or more slots allocated to the first wireless node; and receiving, by the first wireless node from the controller, a message including slot allocation or reallocation information for a second frame, including information indicating that at least one slot of a second set of one or more slots, which were previously allocated to another wireless node, has been reallocated to the first wireless node to enable the first wireless node to retransmit to the controller, during the second frame, data for which there was a failed data transmission during the first frame.

According to an example embodiment, an apparatus may include means for receiving, by a first wireless node from a controller within a wireless network, an allocation of a first set of one or more slots for transmission or retransmission of data at least for a first frame, and wherein each frame includes a plurality of slots; means for transmitting, by the first wireless node to the controller, a packet via each of the slots of the first set of one or more slots allocated to the first wireless node; and means for receiving, by the first wireless node from the controller, a message including slot allocation or reallocation information for a second frame, including information indicating that at least one slot of a second set of one or more slots, which were previously allocated to another wireless node, has been reallocated to the first wireless node to enable the first wireless node to retransmit to the controller, during the second frame, data for which there was a failed data transmission during the first frame.

According to an example embodiment, an apparatus may include: at least one processor; and at least one memory including computer program code; the at least one memory and the computer program code configured to, with the at least one processor, cause the apparatus at least to: receive, by a first wireless node from a controller within a wireless network, an allocation of a first set of one or more slots for transmission or retransmission of data at least for a first frame, and wherein each frame includes a plurality of slots; transmit, by the first wireless node to the controller, a packet via each of the slots of the first set of one or more slots allocated to the first wireless node; and receive, by the first wireless node from the controller, a message including slot allocation or reallocation information for a second frame, including information indicating that at least one slot of a second set of one or more slots, which were previously allocated to another wireless node, has been reallocated to the first wireless node to enable the first wireless node to retransmit to the controller, during the second frame, data for which there was a failed data transmission during the first frame.

According to an example embodiment, a non-transitory computer-readable storage medium may include instructions stored thereon that, when executed by at least one processor, are configured to cause a computing system to receive, by a first wireless node from a controller within a wireless network, an allocation of a first set of one or more slots for transmission or retransmission of data at least for a first frame, and wherein each frame includes a plurality of slots; transmit, by the first wireless node to the controller, a packet via each of the slots of the first set of one or more slots allocated to the first wireless node; and receive, by the first wireless node from the controller, a message including slot allocation or reallocation information for a second frame, including information indicating that at least one slot of a second set of one or more slots, which were previously allocated to another wireless node, has been reallocated to the first wireless node to enable the first wireless node to retransmit to the controller, during the second frame, data for which there was a failed data transmission during the first frame.

According to an example embodiment, a method may include receiving, by a second wireless node from a controller within a wireless network for a first, an allocation of a second set of one or more slots for transmission or retransmission of data at least for the first frame, and wherein each frame includes a plurality of slots; transmitting, by the first wireless node to the controller, packets via the slots of the second set of one or more slots allocated to the second wireless node; and receiving, by the second wireless node from the controller, a message including slot allocation or reallocation information for a second frame, including information indicating that all slots of the second set of one or more slots, which were previously allocated to the second wireless node, have been reallocated to the first wireless node to enable the first wireless node to retransmit to the controller, during the second frame, data for which there was a failed data transmission during the first frame.

According to an example embodiment, an apparatus may include means for receiving, by a second wireless node from a controller within a wireless network for a first, an allocation of a second set of one or more slots for transmission or retransmission of data at least for the first frame, and wherein each frame includes a plurality of slots; means for transmitting, by the first wireless node to the controller, packets via the slots of the second set of one or more slots allocated to the second wireless node; and means for receiving, by the second wireless node from the controller, a message including slot allocation or reallocation information for a second frame, including information indicating that all slots of the second set of one or more slots, which were previously allocated to the second wireless node, have been reallocated to the first wireless node to enable the first wireless node to retransmit to the controller, during the second frame, data for which there was a failed data transmission during the first frame.

According to an example embodiment, an apparatus may include: at least one processor; and at least one memory including computer program code; the at least one memory and the computer program code configured to, with the at least one processor, cause the apparatus at least to: receive, by a second wireless node from a controller within a wireless network for a first, an allocation of a second set of one or more slots for transmission or retransmission of data at least for the first frame, and wherein each frame includes a plurality of slots; transmit, by the first wireless node to the controller, packets via the slots of the second set of one or more slots allocated to the second wireless node; and receive, by the second wireless node from the controller, a message including slot allocation or reallocation information for a second frame, including information indicating that all slots of the second set of one or more slots, which were previously allocated to the second wireless node, have been reallocated to the first wireless node to enable the first wireless node to retransmit to the controller, during the second frame, data for which there was a failed data transmission during the first frame.

According to an example embodiment, a non-transitory computer-readable storage medium may include instructions stored thereon that, when executed by at least one processor, are configured to cause a computing system to receive, by a second wireless node from a controller within a wireless network for a first, an allocation of a second set of one or more slots for transmission or retransmission of data at least for the first frame, and wherein each frame includes a plurality of slots; transmit, by the first wireless node to the controller, packets via the slots of the second set of one or more slots allocated to the second wireless node; and receive, by the second wireless node from the controller, a message including slot allocation or reallocation information for a second frame, including information indicating that all slots of the second set of one or more slots, which were previously allocated to the second wireless node, have been reallocated to the first wireless node to enable the first wireless node to retransmit to the controller, during the second frame, data for which there was a failed data transmission during the first frame.

According to an example embodiment, a method may include allocating, by a controller to each of a plurality of wireless nodes within a wireless network provided for a patient monitoring system, at least one initial slot for transmission of new data in a first frame and at least one retransmission slot for retransmission of data in one or more subsequent frames, wherein each frame includes a plurality of slots, wherein the wireless nodes include at least a first wireless node and a second wireless node, wherein the allocating includes allocating to the second wireless node at least a first retransmission slot for data retransmission in one or more frames subsequent to a first frame; determining, by the controller based on data transmissions performed during the first frame, that there is a failed data transmission from the first wireless node during the first frame; determining, by the controller based on data transmissions performed during the first frame, that the second wireless node does not need the at least the first retransmission slot that was allocated to the second wireless node for data retransmission for one or more frames subsequent to the first frame; and transmitting, by the controller to the plurality of wireless nodes including at least the first wireless node and the second wireless node, a retransmission slot allocation message including information indicating that the at least the first retransmission slot that was allocated to the second wireless node for data retransmission has been allocated to the first wireless node for at least one frame subsequent to the first frame.

According to an example embodiment, an apparatus may include means for allocating, by a controller to each of a plurality of wireless nodes within a wireless network provided for a patient monitoring system, at least one initial slot for transmission of new data in a first frame and at least one retransmission slot for retransmission of data in one or more subsequent frames, wherein each frame includes a plurality of slots, wherein the wireless nodes include at least a first wireless node and a second wireless node, wherein the means for allocating includes means for allocating to the second wireless node at least a first retransmission slot for data retransmission in one or more frames subsequent to a first frame; means for determining, by the controller based on data transmissions performed during the first frame, that there is a failed data transmission from the first wireless node during the first frame; means for determining, by the controller based on data transmissions performed during the first frame, that the second wireless node does not need the at least the first retransmission slot that was allocated to the second wireless node for data retransmission for one or more frames subsequent to the first frame; and means for transmitting, by the controller to the plurality of wireless nodes including at least the first wireless node and the second wireless node, a retransmission slot allocation message including information indicating that the at least the first retransmission slot that was allocated to the second wireless node for data retransmission has been allocated to the first wireless node for at least one frame subsequent to the first frame.

According to an example embodiment, an apparatus may include: at least one processor; and at least one memory including computer program code; the at least one memory and the computer program code configured to, with the at least one processor, cause the apparatus at least to: allocate, by a controller to each of a plurality of wireless nodes within a wireless network provided for a patient monitoring system, at least one initial slot for transmission of new data in a first frame and at least one retransmission slot for retransmission of data in one or more subsequent frames, wherein each frame includes a plurality of slots, wherein the wireless nodes include at least a first wireless node and a second wireless node, wherein the allocating includes allocating to the second wireless node at least a first retransmission slot for data retransmission in one or more frames subsequent to a first frame; determine, by the controller based on data transmissions performed during the first frame, that there is a failed data transmission from the first wireless node during the first frame; determine, by the controller based on data transmissions performed during the first frame, that the second wireless node does not need the at least the first retransmission slot that was allocated to the second wireless node for data retransmission for one or more frames subsequent to the first frame; and transmit, by the controller to the plurality of wireless nodes including at least the first wireless node and the second wireless node, a retransmission slot allocation message including information indicating that the at least the first retransmission slot that was allocated to the second wireless node for data retransmission has been allocated to the first wireless node for at least one frame subsequent to the first frame.

According to an example embodiment, a non-transitory computer-readable storage medium may include instructions stored thereon that, when executed by at least one processor, are configured to cause a computing system to allocate, by a controller to each of a plurality of wireless nodes within a wireless network provided for a patient monitoring system, at least one initial slot for transmission of new data in a first frame and at least one retransmission slot for retransmission of data in one or more subsequent frames, wherein each frame includes a plurality of slots, wherein the wireless nodes include at least a first wireless node and a second wireless node, wherein the allocating includes allocating to the second wireless node at least a first retransmission slot for data retransmission in one or more frames subsequent to a first frame; determine, by the controller based on data transmissions performed during the first frame, that there is a failed data transmission from the first wireless node during the first frame; determine, by the controller based on data transmissions performed during the first frame, that the second wireless node does not need the at least the first retransmission slot that was allocated to the second wireless node for data retransmission for one or more frames subsequent to the first frame; and transmit, by the controller to the plurality of wireless nodes including at least the first wireless node and the second wireless node, a retransmission slot allocation message including information indicating that the at least the first retransmission slot that was allocated to the second wireless node for data retransmission has been allocated to the first wireless node for at least one frame subsequent to the first frame.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a diagram illustrating a medical body area network (MBAN) according to an example embodiment.

FIG. 2 is a block diagram of a medical body area network according to an example embodiment.

FIG. 3 is a diagram illustrating a frame structure according to an example embodiment.

FIG. 4 is a diagram illustrating an initial allocation of slots for transmission of new data in frame 1 and for retransmission of failed data in frame 2 according to an example embodiment.

FIG. 5 is a diagram illustrating a reallocation of some slots in frame 2 for data retransmissions based on transmissions performed in frame 1.

FIG. 6 is a diagram illustrating reallocation of slots for frame 3 based on the data transmissions performed in one or more previous frames.

FIG. 7 is a flow chart illustrating operation of a hub or controller according to an example embodiment.

FIG. 8 is a flow chart illustrating operation of a wireless node according to an example embodiment.

FIG. 9 is a flow chart illustrating operation of wireless node according to another example embodiment.

FIG. 10 is a flow chart illustrating operation of a hub or controller according to another example embodiment.

### DETAILED DESCRIPTION

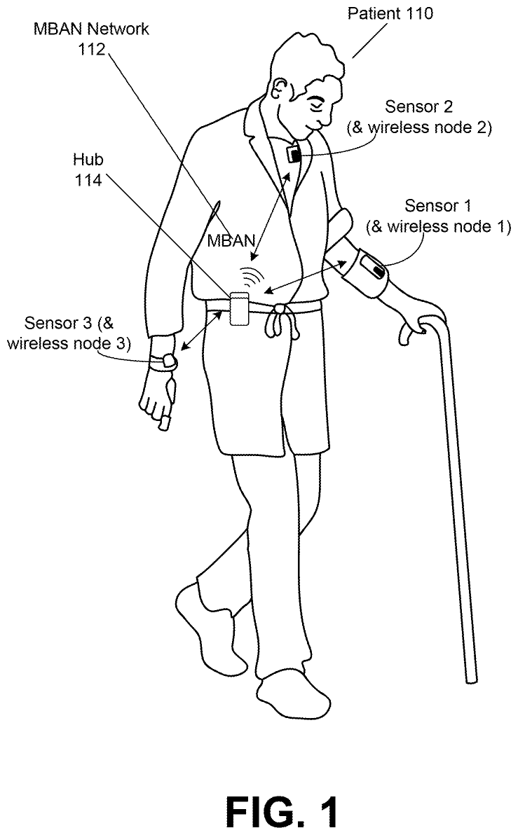

FIG. 1 is a diagram illustrating a medical body area network (MBAN) according to an example embodiment. As shown in FIG. 1, a medical body area network (MBAN or MBAN network) 112 may be provided for patient 110. The MBAN 112 may include a hub (or controller) 114 and one or more sensors to measure patient conditions or physiological measurements. A wireless node (e.g., which may include a wireless transmitter/receiver or transceiver) may be connected to each sensor to communicate with the hub (or controller) 114. For example, sensor 1 may measure the patient's glucose level, and wireless node 1 (connected to sensor 1) may transmit this glucose level data for the patient to hub 114; sensor 2 may measure the patient's heart rate and wireless node 2 (connected to senor 2) may transmit this heart rate data to the hub 114; and sensor 3 may measure the patient's pulse and wireless node 3 (connected to sensor 3) may transmit this pulse rate data for the patient to the hub 114. The hub 114 may be located near the patient 110 and/or attached to the patient 110, or hub 114 may be located somewhere within the patient's room, or in proximity to the patient, for example.

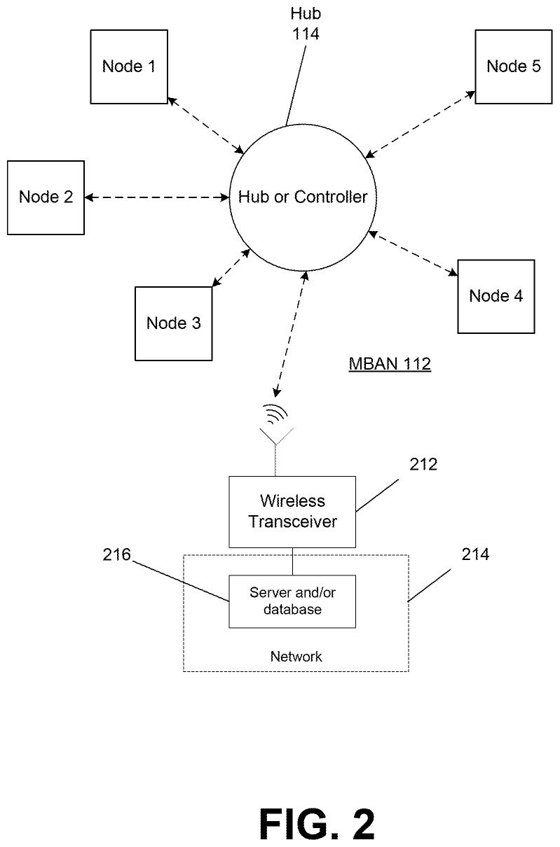

FIG. 2 is a block diagram of a medical body area network according to an example embodiment. Similar to what is shown in FIG. 1, a MBAN (or MBAN network) 112 may include a hub (or controller) 114, which is connected to and/or in communication with one or more wireless nodes, e.g., such as node 1, node 2, node 3, node 4, node 5, etc. As noted, each wireless node may be connected or in communication with an associated sensor that monitors and/or collects patient data. Each of the wireless nodes may communicate (e.g., via wireless link or radio link) with hub 114, e.g., to request wireless resources, receive control information, and/or to transmit patient data to the hub 114.

Also, with reference to FIG. 2, in some cases, hub 114 may forward patient data (e.g., received from any of the wireless nodes 1-5) to a server and/or database 216, which may be provided within or as part of a network 214, which may be, e.g., a local area network (LAN), a cloud-based network, or other network, that may store patient data, for example. A wireless transceiver 212 may establish a connection or communicate with hub 114 to receive the patient data that was reported by any of nodes 1-5 to hub 114. The patient data may be stored within server and/or database 216, for example.

Each of wireless nodes 1-5 and/or the hub (or controller) 114, may include a wireless transmitter/receiver (wireless transceiver) for transmitting and/or receiving information or signals via radio link or wireless link. Each of wireless nodes 1-5, hub (or controller) 114 and/or server and/or data base 216 may include a processor, memory, and computer program code (or software) that may be executed by the processor to perform the various functions, tasks and/or operations described herein.

Therefore, according to various example embodiments, techniques are described that may allow for (e.g., a dynamic, after each frame) reallocation of a slot(s) from a second wireless node that does not need the slot(s) for retransmission to a first wireless node that suffered a failed transmission/retransmission (and thus, has or may have a need for additional slots or wireless resources) for retransmission of data during a next frame. For example, the second wireless node may have transmitted all of its data to the hub 114, and therefore, may not need to perform data retransmission during a next frame. As a result, any slots that may have been allocated or assigned to the second wireless node for retransmission may be reallocated to other node(s) (such as the first wireless node) that may have suffered a failed data transmission, and thus may need to perform a data retransmission during a next frame.

According to an example embodiment, a method or technique may include allocating, by a controller (e.g., hub or controller 114, FIGS. 1-2) to each of a plurality of wireless nodes (e.g., wireless nodes 1-3 in FIG. 1, or wireless nodes 1-5 in FIG. 2), at least one initial slot for transmission of new data in a first frame (e.g., in frame 1) and at least one retransmission slot for retransmission of data in one or more subsequent frames (e.g., at least for frame 2), including allocating to a second wireless node (e.g., node 2) at least a first retransmission slot for data retransmission in one or more frames subsequent to a first frame (e.g., where such reallocated slot may be used for retransmission of data during a second frame or frame 2 by a wireless node receiving such reallocated slot); determining (e.g., by the hub or controller 114) that there is a failed data transmission from a first wireless node during a first frame (e.g., where hub may detect a failed retransmission of data on any assigned slot if the hub 114 does not receive a data packet or an empty/null packet for such allocated slot); determining (e.g., by the hub 114) that the second wireless node (e.g., node 2) does not need the at least the first retransmission slot (e.g., because the hub 114 has received data packet or null/empty packet for each slot initially assigned to the second wireless node, and thus the second wireless node no longer needs its allocated slots for data retransmission); and transmitting a retransmission slot allocation message including information indicating that the at least the first retransmission slot has been allocated to the first wireless node (e.g., node 1) for at least one frame subsequent to the first frame. In this manner, a slot(s) that may have been allocated to the first wireless node may be reallocated to the second wireless node if the second wireless node no longer needs to retransmit data (e.g., hub 114 may have detected that data has been received by hub 114 via slots (e.g., all the slots) allocated to second wireless node, and thus, the second wireless node no longer needs to perform data retransmission), and the first wireless node (e.g., node 1) had at least one failed data transmission in the last or most recent frame and thus needs to perform a data retransmission during a next frame(s) (and thus node 1 may be able to use the additional wireless resources or slots to improve probability of a successful data transmission to hub 114). In this manner, a more efficient allocation of wireless resources (e.g., slots) within a MBAN network 112 may be provided, e.g., by the hub (or controller) 114 reallocating slots (e.g., unneeded slots) from a node(s) that no longer needs their slots for a subsequent frame for data retransmission, to another wireless node(s) that may have a need for such additional or reallocated slot(s) to perform data retransmission in the subsequent frame.

The use of the terms first wireless node and second wireless node may refer to any wireless nodes. Unneeded slots (e.g., slots that were allocated to the second node, but the second node no longer needs to perform retransmissions) may be reallocated from the second wireless node to one or more other nodes, such as to the first wireless node, which may need or be able to use such reallocated slots for retransmission. Also, free slots (unused or unallocated slots) may be allocated to the first node or other nodes that may need to retransmit data. After receiving such reallocation of data slots, the first node (or any node that may need to retransmit data or which had a failed data transmission during the last frame) may (during the next frame) use any of its allocated slots (either slots originally assigned to it for initial transmission, or any slot subsequently allocated or reallocated to such wireless node) to retransmit data that may need to be retransmitted (e.g., data which failed or was not (or has not been) received by the hub or controller). Allocation or reallocation may take place after any frame (e.g., excluding the last transmission frame of a set of 3 superframes, since initial transmission of new data may be performed during a first frame of the set of three superframes, for example).

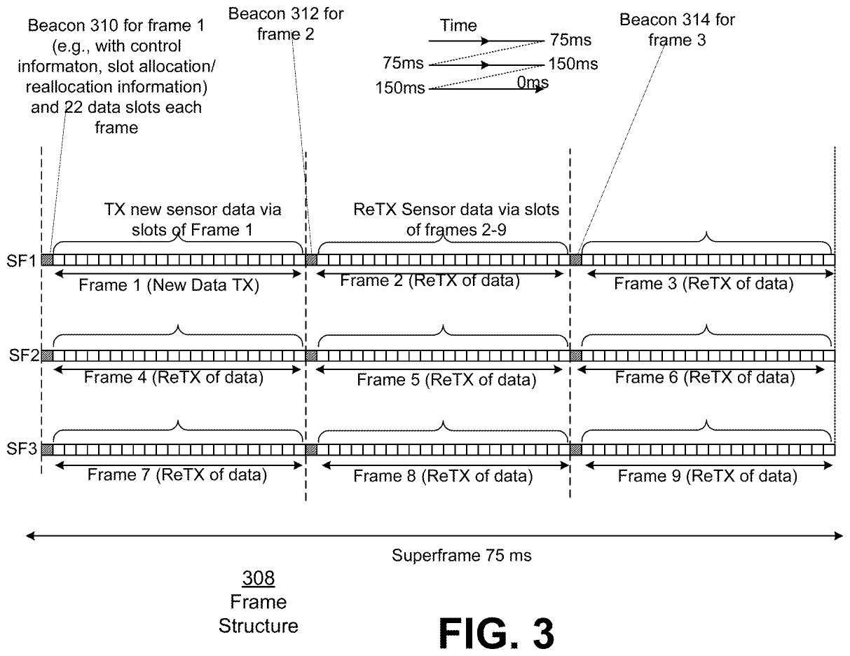

FIG. 3 is a diagram illustrating a frame structure according to an example embodiment. Example frame structure 308 may be used by hub 114 and wireless nodes to communicate as part of the MBAN network 112 (see FIGS. 1-2). The basic frame structure 308 may include three superframes (SFs), including SF1, SF2 and SF3. Each superframe (SF) may, for example, be 75 ms, and may include 3 frames (as an example). Thus, in this example frame structure, there may be a total of 9 frames for frame structure 308, including three superframes (SFs), where SF1 may include frames 1-3; SF2 may include frames 4-6; and SF3 may include frames 7-9, according to this illustrative example.

Each frame may be, e.g., 25 ms in length, and may include, for example, at least a beacon (or beacon slot, e.g., for transmission of a beacon message by controller or hub 114) and 22 data slots (data slots 1-22, or simply slots 1-22).

According to an example embodiment, frame 1 (or the first frame of the frame structure 308) includes 22 data slots for transmission of new data (e.g., uplink transmission of new data from wireless node(s) to hub 114, where new data is data that has not been transmitted before), and frames 2-9 may be provided for retransmission of failed data (or data that was not successfully transmitted or was not successfully received by hub 114. Thus, in this example, frame 1 includes slots for initial transmission of new data, and frames 2-9 include slots for retransmission of any data that failed or was not received by the hub 114.

Thus, according to an example embodiment, frame structure 308 may provide or allow for transmission (or initial transmission) of new data via allocated slot(s) in frame 1, and may allow for retransmission of data via slot(s) of any (or one or more of) frames 2-9, as needed (e.g., if the new data was not successfully transmitted or delivered to hub 114). Thus, according to an example embodiment, in order to improve transmission reliability and reduce latency, a wireless node may use any slots assigned to it to initially transmit new data within or during frame 1, and the wireless node may then use any assigned slots in subsequent frames 2-9 for retransmission of failed data (data that was not received by hub or controller 114). Thus, as noted, in this illustrative example, frame 1 may be used to initially transmit new data, and frames 2-9 may be used, if necessary, to retransmit any failed data (data that was not successfully transmitted or was not delivered to the hub 114).

As noted with respect to FIGS. 1-2, each of the wireless nodes may be connected to a sensor, and may periodically or on demand, report patient data to hub 114. Each wireless node may request wireless resources (e.g., request one or more slots) from hub 114, or may indicate an amount of data to be reported or transmitted to the hub 114, and/or may indicate quality of service requirement, such as data rate, maximum latency, etc. for the sensor associated with the wireless node. Hub (or controller) 114 may then initially allocate one or more slots within frame 1 for transmission of new data and one or more slots within frames 2-9 for retransmission of failed data. As described in greater detail below, this initial allocation of slots within frames 2, 3, 4, . . . 9 may be adjusted by hub 114 based on the transmissions that were performed for the previous frame, e.g., to allow hub 114 to reallocate unneeded slots from a node that may not need to perform data retransmission to a node that may have data for retransmission (based on a failed data transmission).

A beacon may include control and/or management information transmitted (e.g., broadcast) by the hub (or controller) 114 to the wireless nodes. A beacon may include, for example, acknowledgements that may acknowledge receiving a packet for 1 or more (or each) of the allocated slots in the previous frame, or negative acknowledgements that may indicate that a packet was not received on one or more allocated slots of a previous frame, and e.g., may be indicated as a bit map to indicate for which slots a packet was received and/or was not received. Thus, such acknowledgement or negative acknowledgement information may inform a wireless node of data transmitted via a particular allocated slot that failed or was not received by the hub 114 and needs to be retransmitted during a next or subsequent frame, for example.

A beacon may also include, for example, slot allocation or slot reallocation information that includes or may indicate an allocation (or assignment) or reallocation (or re-assignment) of one or more slots (data slots) for the current (next) frame. For example, a beacon 310 is provided for frame 1, and may indicate an initial allocation of one or more slots for each of a plurality of wireless nodes; a beacon 312 is provided for frame 2 and may indicate an allocation and/or reallocation of slots for frame 2; and a beacon 314 is provided for frame 3, which may indicate an allocation or reallocation of slots for frame 3. The other frames 4-9 may also typically include a beacon.

Thus, according to an example embodiment, hub 114 may initially allocate slot(s) to one or more wireless nodes for transmission of new data within frame 1, and may initially allocate slot(s) to the one or more wireless nodes for retransmission of data for subsequent frames (e.g., frames 2-9) that are provided for retransmission of data. In an illustrative example embodiment, hub 114 may initially allocate a same slots for both transmission of new data in frame 1, and retransmission of data in frame 2 (or for retransmission of data via subsequent frames 2-9). However, as described hereinbelow, one or more slots allocated to wireless nodes for retransmission of data (e.g., allocated for one or more of frames 2, 3, . . . 9) that are no longer needed by a wireless node may be reallocated to another wireless node (that may have had a failed data transmission) to be used for data retransmission, e.g., in order to improve data transmission reliability and decreased latency via improved use of wireless resources or slots within the frame structure.

In one example, the same slots allocated to a node for frame 1 (transmission of new data) may also be initially allocated to the wireless node for retransmission of data in frames 2, 3, . . . 9 (but these allocations of slots may be adjusted based on data transmissions performed by the wireless nodes, and/or based on packets received by the hub 114 after each frame. For example, slot 9 may be allocated to node 1 for both frame 1 (transmission of new data) and initially allocated to node 1 for frame 2 (for retransmission of data that failed or was not received by hub 114). Although, in general, different slots may be assigned to a wireless node for new data transmission of frame 1, and for retransmissions in frame 2.

According to an example embodiment, after all 9 frames (after frames 1-9, including after all 3 superframes, SF1-SF3) of the frame structure 308 have occurred, the frame structure 308 may repeat itself, e.g., wireless nodes may transmit new data again via slots allocated or assigned to them for frame 1 for transmission of new data, and then the nodes may have opportunities to retransmit failed data via allocated slots of frames 2-9 (e.g., subject to one or more of such slots, that are no longer needed, being reallocated by hub 114 to other nodes).

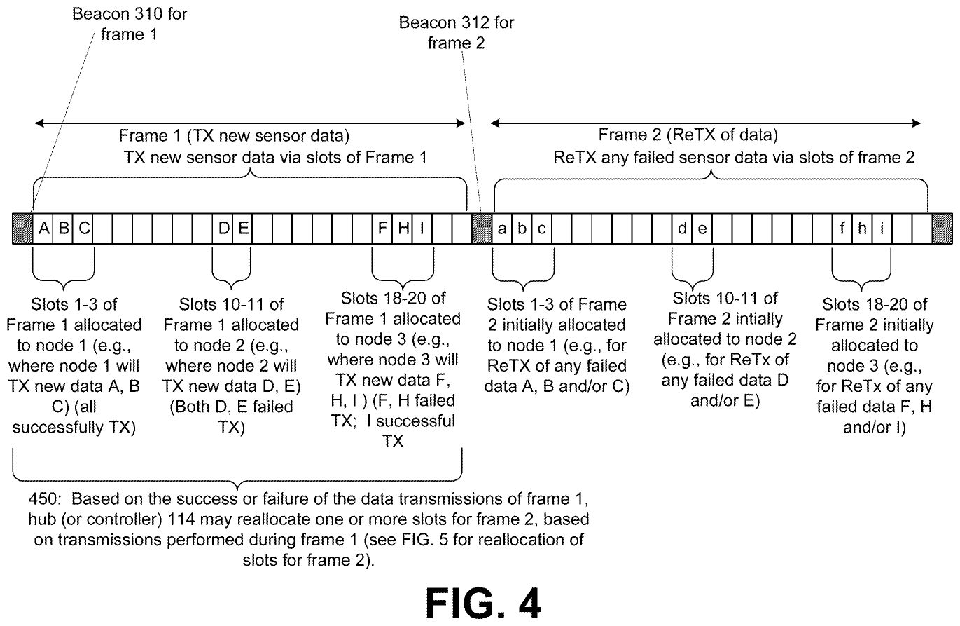

FIG. 4 is a diagram illustrating an initial allocation of slots for transmission of new data in frame 1 and for retransmission of failed data in frame 2 according to an example embodiment. As shown in FIG. 4, frame 1 and frame 2 are shown. For frame 1 (e.g., for transmission of new data), slots 1-3 (the first 3 data slots of frame 1) are allocated by hub 114 to node 1, where node 1 may have new data A, B and C to be transmitted to hub 114, where A, B and C may represent different patient sensor data samples to be reported to hub 114. Upper case letters (e.g., A, B C) represent new data (or possible transmission of new data), while lower case letters (e.g., a, b c) represent retransmitted data or slots for retransmission of any of data a, b, c, from node 1 which received such slot allocations). Likewise, hub 114 has initially allocated slots 1-3 of frame 2 for retransmission of any data that may need to be retransmitted by node 1, such as for retransmission of any of failed data A, B, C, which are shown in slots 1-3 as a, b, c (lower case letters representing retransmitted data or slots for the possible retransmission of failed data, for example). The lower case letters a, b, c are shown for slots 1-3, respectively of frame 2, but node 1 may use any of slots 1-3 of frame 2 to retransmit any of data a, b or c, for example. Data a, b and c (lower case letters) may be the same data as upper case letters A, B and C, respectively, but the lower case letters indicate retransmitted data or slots for possible retransmission of data as needed, while upper case letters (e.g., A, B, C) represent transmission of new data. The same applies for other data (other letters, such as D, E, F H and I) shown for frame 1 (upper case letters representing transmission of new data) and for frames 2-9 (lower case letters representing retransmission slots for possible retransmission of data that needs to be retransmitted such as data that failed transmission/retransmission).

Similarly, for frame 1 (which include slots allocated to nodes for transmission of new data), slots 10-11 of frame 1 have been allocated to node 2, e.g., for transmission of new data D, E, while slots 10-11 of frame 2 have been initially allocated to node 2 to allow node 2 to perform retransmission of any failed data (e.g., retransmission of any of data d or e, corresponding to new data D, E, respectively which may have failed transmission within frame 1) to hub 114. While data d is shown for slot 10 and data e is shown for slot 11, node 2 may use either (or any) of its allocated slots in frame 2 to retransmit any failed data (e.g., any of slots 10 or 11 may be used to retransmit any of data d, e, which may have failed or were not received by hub 114.

Similarly, for frame 1 (which include slots allocated to nodes for transmission of new data), slots 18-20 of frame 1 have been allocated by hub 114 to node 3, e.g., for transmission of new data F, H, I, while slots 18-20 of frame 2 have been initially allocated to node 3 to allow node 3 to perform retransmission of any failed data (e.g., retransmission of any of data f, h or i, corresponding to new data F, H or I, respectively which may have failed transmission in frame 1) to hub 114. While data f is shown for slot 18, data h is shown for slot 19, and data i is shown for slot 20 of frame 2, node 3 may use any of its allocated slots 18-20 in frame 2 to retransmit any of its failed data (e.g., any of slots 18-20 may be used to retransmit any of data f, h i, which may have failed or were not received by hub 114, according to an example embodiment).

Thus, frame 2 of FIG. 4 illustrates both 1) an allocation of slots to nodes 1, 2 and 3 within frame 1 for transmission of new data, and 2) an initial allocation of slots to nodes 1, 2 and 3 for frame 2 for retransmission of failed data. However, as noted, hub 114 may adjust the slot allocations after each frame to better use available or unneeded slots for retransmission of data that may have failed (was not received by hub 114).

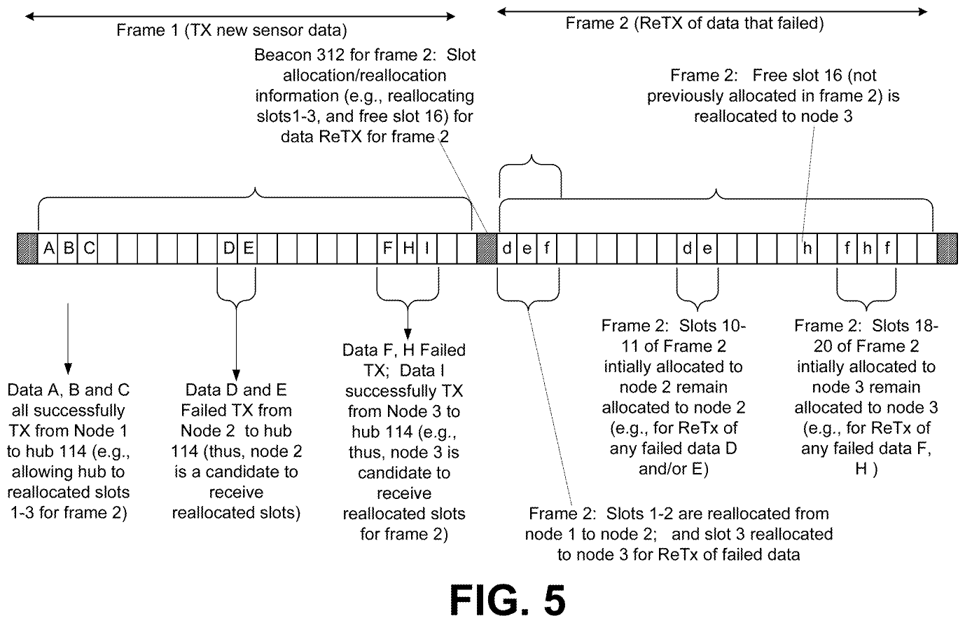

During or at the end of each frame, hub 114 may determine for which allocated slots there was a data transmission failure (or a failed transmission) from one of the wireless nodes (e.g., for which slots was data not received). For example, during, or at the end of frame 1, hub may determine that data A, B and C were successfully received via slots 1-3, respectively of frame 1, that data D and E failed (failed data transmission or were not received by the hub 114) via slots 10-11 of frame 1, and that data F (or slot 18) and data H (slot 19) failed transmission (were not received by hub 114 during frame 1), while data I (slot 20) was received by hub 114. Therefore, hub 114 may determine, based on transmissions performed within frame 1, that data A, B and C were received, both data D and E failed, data I was received, and data F and H failed, according to an example embodiment. At 450 in FIG. 4, it is noted that hub 114 may reallocate one or more slots (that were initially allocated to nodes 1, 2 or 3) to other or different nodes for frame 2, in order to allow for retransmission of failed data (a slot or data for which the hub 114 did not receive the data transmission in frame 1). Frame 2 of FIG. 4 illustrates an initial allocation (e.g., performed before transmissions of frame 1) of slots for frame 2 retransmissions, while frame 2 in FIG. 5 illustrates reallocated slots of frame 2 (e.g., reallocated after transmissions of frame 1), e.g., based on the success or failure of data transmissions of allocated slots in frame 1.

Different or various techniques may be used by hub 114 to determine which allocated slots had data that were received by hub 114 and which allocated slots had a data transmission failure. In one example embodiment, a wireless node will transmit either a data packet or an empty or null packet (e.g., a packet with a header, e.g., destination address and possibly other control information, but no data) via each of its allocated slots. Thus, for example, if hub 114 does not receive a packet (either a data packet or a null/empty packet for an allocated slot), hub 114 assumes or determines that there was a failed data transmission for that allocated slot. For example, if no packet (either a data packet or a null or empty packet) was received by hub 114 in slots 10 or 11 within frame 1, the hub 114 assumes the data (e.g., data d, e) transmitted by node 2 failed or was not received, and thus, more slots should or may be allocated to node 2 for a subsequent frame (e.g., for frame 2) to increase the probability of a successful data retransmission for these data d, e, which suffered a failed data transmission in frame 1. As another technique for hub 114 to determine which slots for which there was a failed data transmission, each of the nodes with allocated slots may transmit to hub 114 a bit map that may indicate which slots the node is transmitting (or has transmitted) data (and thus, slots for which data was transmitted, and/or empty slots may be identified by hub 114 via the bit map(s), for example).

FIG. 5 is a diagram illustrating a reallocation of some slots in frame 2 for data retransmissions based on transmissions performed in frame 1. As noted, in frame 1, data A, B and C from node 1 were successfully transmitted (received by hub 114); data D and E from node 2 failed (were not received by hub 114); data F and H from node 3 failed (were not received by hub 114), and data I was successfully transmitted (was received by hub 114). For example, after each frame, such as after frame 1 in FIG. 5, hub 114 may determine for which slots there was a transmission failure, e.g., slots 10, 11 and 20 in this example. According to an example embodiment, after each frame, based on the data transmissions performed during a previous frame, hub 114 may reallocate one or more slots from a node that has transmitted all of its data (no pending failed data transmissions during last frame) to a node that has at least one failed data transmission during the last frame (e.g., during frame 1). Thus, as shown in FIG. 5, hub 114 may determine that node 1 has successfully transmitted all of its data (there are no failed data transmissions for slots 1-3, allocated to node 1, for data A, B, C), e.g., by hub 114 receiving either a data packet or a null or empty packet during or for each of slots 1-3 during frame 1. Hub 114 may also determine that there was a data transmission failure for slots 10 and 11 (for data D, E) during frame 1 for node 2, since no data or null packet was received by hub 114 for either of these slots 10 or 11 during frame 1. And, hub 114 may determine that there was a data transmission failure for slots 18 and 19 (data F, H), but data for slot 20 was successfully received.

Thus, to summarize with respect to FIG. 5 after transmissions of frame 1, node 1 can be a slot donor, since node 1 has transmitted all of its data (no data transmission failures for node 1 during frame 1), while nodes 2 and 3 may be slot recipients for a reallocation of slots as they each had at least data transmission failure during frame 1, and thus will need to retransmit this failed data during frame 2. Therefore, according to an example embodiment, as shown for frame 2 of FIG. 5, slots 1-3 are reallocated by hub 114 from node 1 to node 2 (thus, allowing node 2 to retransmit any of its data d, e via these reallocated slots during frame 2). Slots 10-11, which were initially allocated to frame 2 before data transmissions occurred within frame 1, will remain allocated to node 2 because node 2 has at least one failed data transmission and thus node 2 may use these slots for data retransmission within frame 2. To provide additional slot resources, hub 114 may allocate free slot 16 (which was not previously allocated or used by a node within frame 1) to node 3 to allow node 3 to retransmit any of its failed data for this slot in frame 2 (e.g., data h is shown for slow 16). Also slots 18-20 that were initially allocated by hub 114 before transmission of data within frame 1 will remain allocated to node 3 because node 3 has at least one failed data transmission in the previous frame (e.g., due to failed data transmission F, H via slots 18, 19 from node 3 within frame 1).

In this manner, hub 114 may dynamically reallocate or reassign slots for frame 2 based on the transmissions that were performed during frame 1, e.g., including possibly reallocating one or more slots that are no longer needed (e.g., such as slots 1-3) and/or from a node (e.g., node 1) that did not have any data transmission failures during frame 1, to a node (e.g., such as nodes 2 and/or 3) that had at least one data transmission failure during frame 1 or the previous frame). Also, hub 114 may allocate one or more or all of the unallocated or free slots (e.g., such as free slot 16) to one or more of the nodes that need to retransmit data during the next frame (e.g., frame 2). Hub 114 may transmit a beacon 312 at the beginning of frame 2 that may include slot allocation/reallocation information that indicates that slots 1-3 are reallocated, and free slot 16 is allocated now).

Also, in this illustrative example, during data transmissions for frame 2, the retransmissions for data e, f and h were successful (and as noted, data transmissions for data A, B and C were previously successful during frame 1), but the data transmission for data d failed during frame 2. Thus, no data transmission failure was detected for node 3, and a data transmission failure was detected for node 2. Also, for example, an acknowledgement sent by hub 114 to node 2 may have indicated that no packet was received for a slot(s) for which data d was transmitted by node 2. Thus, a data transmission failure occurred during frame 2 for node 2, but all of the other new data (A, B, C, E, F, H and I) have now been successfully transmitted and received by hub 114. Thus, node 2 remains a possible slot recipient for frame 3 based on the data transmission failure(s) for node 2 (e.g., data d) during frame 2.

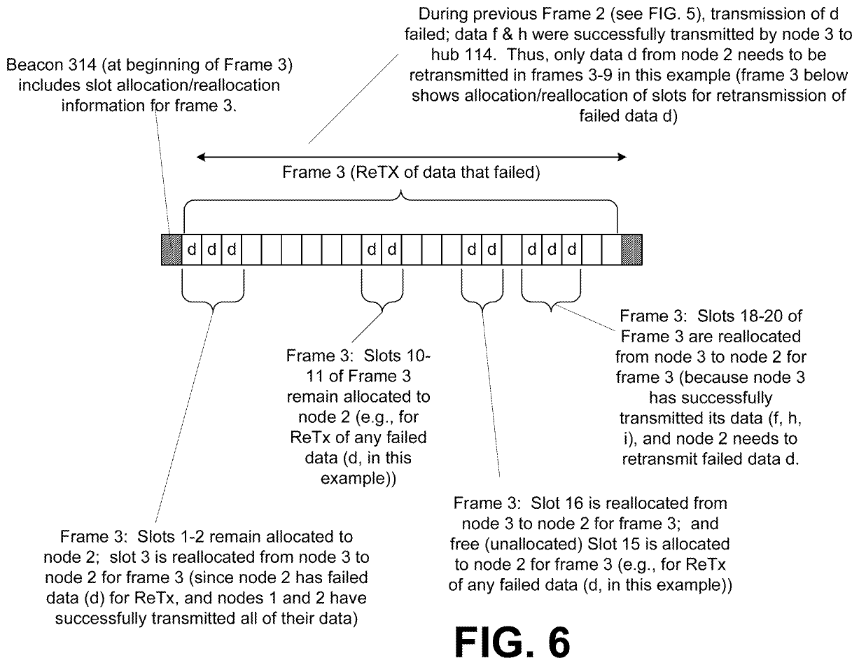

FIG. 6 is a diagram illustrating reallocation of slots for frame 3 based on the data transmissions performed in one or more previous frames. A beacon 314, transmitted by hub 114 at the beginning of frame 3, may indicate an allocation or reallocation of one or more slots for frame 3. As shown in FIG. 6, slots 1-3 and slots 10-11 will remain allocated to node 2 because node 2 had a data transmission failure during the previous frame (e.g., during frame 2, for data d), and thus, node 2 may use (and has a need for) these slots for data transmission during frame 3. Slot 16 is reallocated from node 3 to node 2 (since node 3 has no need for retransmission slots, since node 3 successfully transmitted all of its data, e.g., F, H and I, and/or had no retransmission failures during a last frame). Also, free slot 15 is allocated to node 2 for frame 3, e.g., to provide additional retransmission resources for node 2. And, slots 18-20 of frame 3 are reallocated by hub 114 from node 3 to node 2, since node 3 no longer has a need for these slots for retransmissions (as noted, node 3 had no data transmission failures during the previous frame, and/or all of the data for node 3 have been successfully received by hub 114).

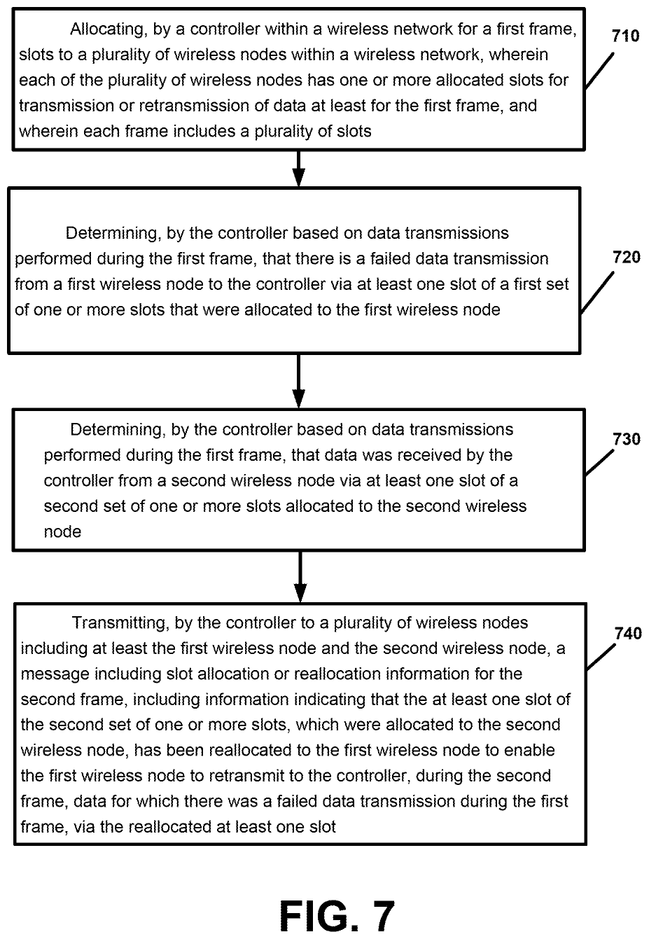

FIG. 7 is a flow chart illustrating operation of a hub or controller according to an example embodiment. Operation 710 may include allocating, by a controller (e.g., hub or controller 114, FIGS. 1-2) within a wireless network for a first frame, slots to a plurality of wireless nodes within a wireless network, wherein each of the plurality of wireless nodes has one or more allocated slots for transmission or retransmission of data at least for the first frame, and wherein each frame includes a plurality of slots. Operation 720 may include determining, by the controller based on data transmissions performed during the first frame, that there is a failed data transmission from a first wireless node to the controller via at least one slot of a first set of one or more slots that were allocated to the first wireless node (e.g., hub or controller 114 detects that patient data that may have been transmitted by a first wireless node was not received by the hub or controller). Operation 730 includes determining, by the controller based on data transmissions performed during the first frame, that data was received by the controller from a second wireless node via at least one slot of a second set of one or more slots allocated to the second wireless node. And, operation 740 includes transmitting, by the controller to a plurality of wireless nodes including at least the first wireless node and the second wireless node, a message including slot allocation or reallocation information for the second frame, including information indicating that the at least one slot of the second set of one or more slots, which were allocated to the second wireless node, has been reallocated to the first wireless node to enable the first wireless node to retransmit to the controller, during the second frame, data for which there was a failed data transmission during the first frame, via the reallocated at least one slot.

According to an example embodiment of the method of FIG. 7, the determining, by the controller based on data transmissions performed during the first frame, that data was received by the controller from a second wireless node via at least one slot of a second set of one or more slots allocated to the second wireless node may include: determining, by the controller, that there was no failed data transmission from the second wireless node to the controller during the first frame.

According to an example embodiment of the method of FIG. 7, the transmitting may include: transmitting, by the controller, the message including slot allocation or reallocation information for the second frame, including information indicating that all slots of the second set of one or more slots, which were allocated to the second wireless node, have been reallocated to the first wireless node to enable the first wireless node to retransmit to the controller, during the second frame, data for which there was a failed data transmission during the first frame.

According to an example embodiment of the method of FIG. 7, each wireless node may be connected to a sensor that collects patient data for transmission to the controller.

According to an example embodiment of the method of FIG. 7, the wireless network may include a medical body area network in which patient data is sensed and/or collected from a patient and transmitted, via one or more of the wireless nodes, to the controller.

According to an example embodiment of the method of FIG. 7, the determining, by the controller based on data transmissions performed during the first frame, that there is the failed data transmission from the first wireless node to the controller via at least one slot of a first set of one or more slots that were allocated to the first wireless node may include: determining, by the controller based on data transmissions performed during the first frame, that there was no packet received by the controller from the first wireless node via at least one slot of a first set of one or more slots that were allocated to the first wireless node, wherein the first wireless node is enabled to transmit either a data packet or a null or empty packet on each slot of the first set of one or more slots allocated to the first wireless node.

According to an example embodiment of the method of FIG. 7, the determining, by the controller based on data transmissions performed during the first frame, that there is the failed data transmission from the first wireless node to the controller via at least one slot of a first set of one or more slots that were allocated to the first wireless node may include: receiving, by the controller from the first wireless node, control information indicating one or more slots, of the first set of one or more slots that were allocated to the first wireless node, for which data will be transmitted or was transmitted during the first frame; and, determining, by the controller based on data transmissions performed during the first frame and the control information received by the controller from the first wireless node, that no data was received by the controller from the first wireless node via at least one slot for which the control information indicated that data was or will be transmitted during the first frame.

According to an example embodiment of the method of FIG. 7, a first subset of one or more slots are used by the wireless nodes for transmission of data, and a second subset of one or more slots are used by the wireless nodes for retransmission of data for which there was a failed data transmission to the controller.

According to an example embodiment of the method of FIG. 7, the message including slot allocation or reallocation information for the second frame, further includes information indicating a reallocation of an empty slot to the first wireless nod, wherein the empty slot was not allocated to any wireless nodes or used for transmission during the first frame, to enable the first wireless node to retransmit to the controller, during the second frame, data for which there was a failed data transmission during the first frame, via the reallocated empty slot.

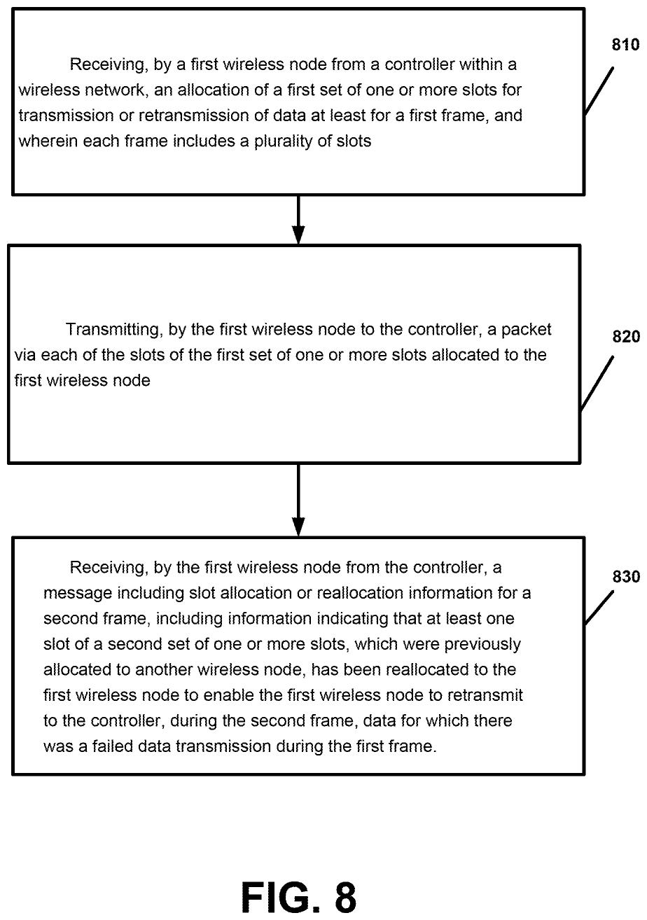

FIG. 8 is a flow chart illustrating operation of a wireless node according to an example embodiment. Operation 810 includes receiving, by a first wireless node from a controller within a wireless network, an allocation of a first set of one or more slots for transmission or retransmission of data at least for a first frame, and wherein each frame includes a plurality of slots. Operation 820 includes transmitting, by the first wireless node to the controller, a packet via each of the slots of the first set of one or more slots allocated to the first wireless node. And, operation 830 includes receiving, by the first wireless node from the controller, a message including slot allocation or reallocation information for a second frame, including information indicating that at least one slot of a second set of one or more slots, which were previously allocated to another wireless node, has been reallocated to the first wireless node to enable the first wireless node to retransmit to the controller, during the second frame, data for which there was a failed data transmission during the first frame.

According to an example embodiment of the method of FIG. 8, the transmitting, by the first wireless node to the controller, a packet via each of the slots of the first set of one or more slots allocated to the first wireless node may include transmitting either a data packet, or a null or empty packet, via each of the slots of the first set of one or more slots allocated to the first wireless node.

The method of FIG. 8 may further include: determining, by the first wireless node, that there was a failed data transmission of a data packet during the first frame; and retransmitting a data packet, associated with data or the data packet for which there was a failed transmission, during the second frame via the reallocated at least one slot that was reallocated to the first wireless node.

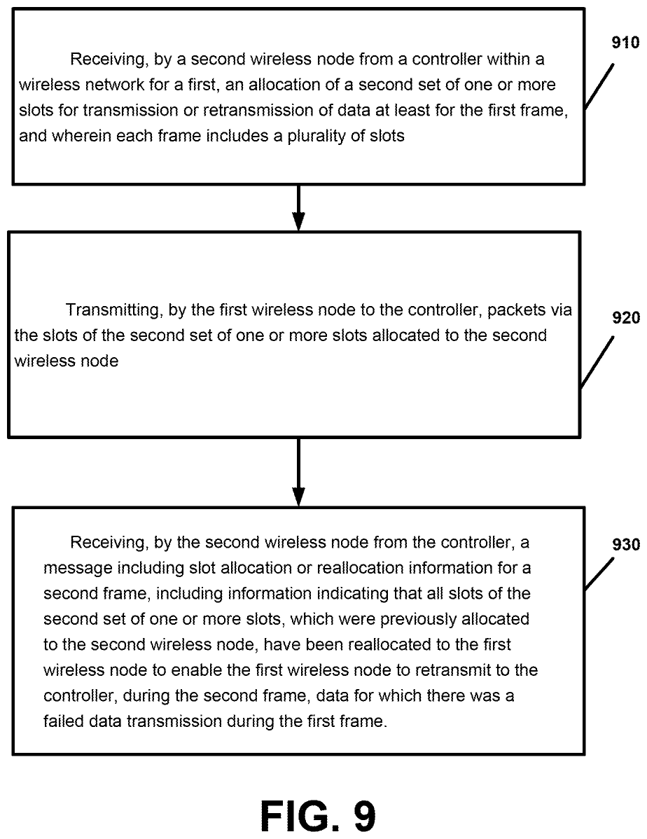

FIG. 9 is a flow chart illustrating operation of wireless node according to another example embodiment. Operation 910 includes receiving, by a second wireless node from a controller within a wireless network for a first, an allocation of a second set of one or more slots for transmission or retransmission of data at least for the first frame, and wherein each frame includes a plurality of slots. Operation 920 includes transmitting, by the first wireless node to the controller, packets via the slots of the second set of one or more slots allocated to the second wireless node. And, operation 930 includes receiving, by the second wireless node from the controller, a message including slot allocation or reallocation information for a second frame, including information indicating that all slots of the second set of one or more slots, which were previously allocated to the second wireless node, have been reallocated to the first wireless node to enable the first wireless node to retransmit to the controller, during the second frame, data for which there was a failed data transmission during the first frame.

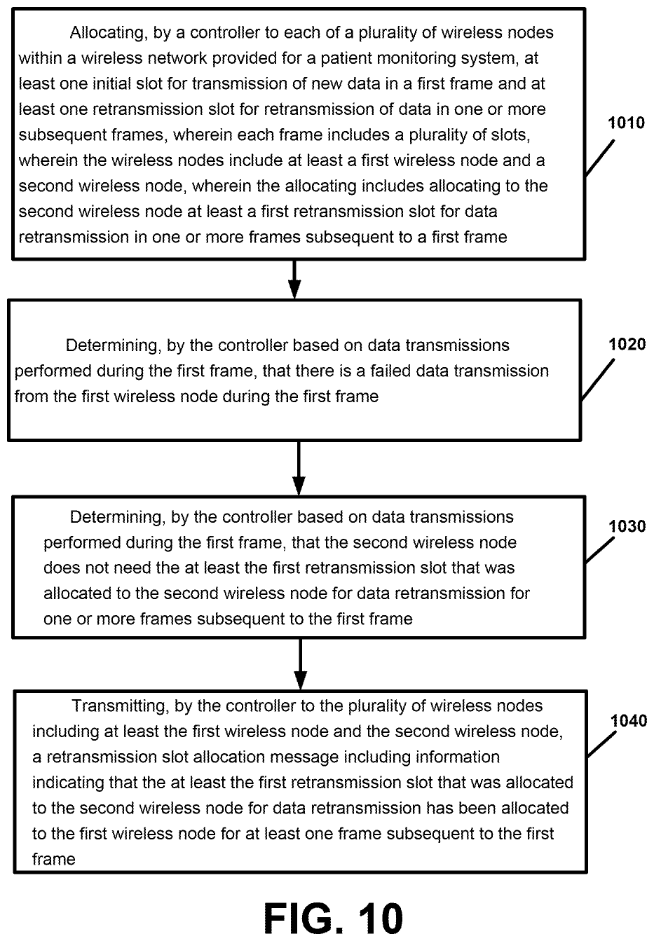

FIG. 10 is a flow chart illustrating operation of a hub or controller according to another example embodiment. Operation 1010 includes allocating, by a controller to each of a plurality of wireless nodes within a wireless network provided for a patient monitoring system, at least one initial slot for transmission of new data in a first frame and at least one retransmission slot for retransmission of data in one or more subsequent frames, wherein each frame includes a plurality of slots, wherein the wireless nodes include at least a first wireless node and a second wireless node, wherein the allocating includes allocating to the second wireless node at least a first retransmission slot for data retransmission in one or more frames subsequent to a first frame. Operation 1020 includes determining, by the controller based on data transmissions performed during the first frame, that there is a failed data transmission from the first wireless node during the first frame. Operation 1030 includes determining, by the controller based on data transmissions performed during the first frame, that the second wireless node does not need the at least the first retransmission slot that was allocated to the second wireless node for data retransmission for one or more frames subsequent to the first frame. And, operation 1040 includes transmitting, by the controller to the plurality of wireless nodes including at least the first wireless node and the second wireless node, a retransmission slot allocation message including information indicating that the at least the first retransmission slot that was allocated to the second wireless node for data retransmission has been allocated to the first wireless node for at least one frame subsequent to the first frame.

According to an example embodiment of the method of FIG. 10, the determining, by the controller based on data transmissions performed during the first frame, that there is the failed data transmission from the first wireless node during the first frame may include: determining, by the controller based on data transmissions performed during the first frame, that there was no packet received by the controller from the first wireless node via at least one initial slot allocated to the first wireless node, wherein the first wireless node is enabled to transmit either a data packet or a null or empty packet on each initial slot allocated to the first wireless node.

According to an example embodiment of the method of FIG. 10, the retransmission slot allocation message is provided within a beacon packet or message that is transmitted at least one of the following: beginning of a frame, or end of a frame.

Various techniques are described that allow an allocation and/or reallocation of slots between wireless nodes, e.g., based on need. Slots from any node (e.g., that may no longer need such slots) may be reallocated to any other node (e.g., to any node that may need or may be able to use such reallocated slots for data retransmission). Thus, according to an example embodiment, unneeded slots may be reallocated between nodes, e.g., including reallocating slots from a node that no longer needs such slots for retransmission (e.g., because all of its data for this set of 3 superframes has been successfully delivered to the hub or controller) to a node that may need to retransmit data (e.g., because at least some data of such node has not yet been successfully delivered to the hub or controller). Also, free or unused slots may be allocated to any node, such as to a wireless node that may need to retransmit data to the hub or controller. After receiving such allocation or reallocation of slots, the node(s) may use such allocated or reallocated slots (as well as any other slots the node may have previously been allocated) to perform data retransmission during a next frame. According to an example embodiment, this process of allocating or reallocating slots to nodes that may need such slots for data retransmission may be repeated after each frame, e.g., until the last frame of the set of three superframes has been reached. According to an illustrative example embodiment, new data may be transmitted during allocated slots of a first frame (e.g., frame 1) of the set of three superframes, while subsequent frames (e.g., frames 2-9) of the set of three superframes may be used for data retransmission, if necessary.

An apparatus may include: at least one processor; and at least one memory including computer program code; the at least one memory and the computer program code configured to, with the at least one processor, cause the apparatus at least to: allocate, by a controller within a wireless network for a first frame, slots to a plurality of wireless nodes within a wireless network, wherein each of the plurality of wireless nodes has one or more allocated slots for transmission or retransmission of data at least for the first frame, and wherein each frame includes a plurality of slots; determine, by the controller based on data transmissions performed during the first frame, that there is a failed data transmission from a first wireless node to the controller via at least one slot of a first set of one or more slots that were allocated to the first wireless node; determine, by the controller based on data transmissions performed during the first frame, that data was received by the controller from a second wireless node via at least one slot of a second set of one or more slots allocated to the second wireless node; and transmit, by the controller to a plurality of wireless nodes including at least the first wireless node and the second wireless node, a message including slot allocation or reallocation information for the second frame, including information indicating that the at least one slot of the second set of one or more slots, which were allocated to the second wireless node, has been reallocated to the first wireless node to enable the first wireless node to retransmit to the controller, during the second frame, data for which there was a failed data transmission during the first frame, via the reallocated at least one slot.

An apparatus may include: at least one processor; and at least one memory including computer program code; the at least one memory and the computer program code configured to, with the at least one processor, cause the apparatus at least to: receive, by a first wireless node from a controller within a wireless network, an allocation of a first set of one or more slots for transmission or retransmission of data at least for a first frame, and wherein each frame includes a plurality of slots; transmit, by the first wireless node to the controller, a packet via each of the slots of the first set of one or more slots allocated to the first wireless node; and receive, by the first wireless node from the controller, a message including slot allocation or reallocation information for a second frame, including information indicating that at least one slot of a second set of one or more slots, which were previously allocated to another wireless node, has been reallocated to the first wireless node to enable the first wireless node to retransmit to the controller, during the second frame, data for which there was a failed data transmission during the first frame.

An apparatus may include: at least one processor; and at least one memory including computer program code; the at least one memory and the computer program code configured to, with the at least one processor, cause the apparatus at least to: receive, by a second wireless node from a controller within a wireless network for a first, an allocation of a second set of one or more slots for transmission or retransmission of data at least for the first frame, and wherein each frame includes a plurality of slots; transmit, by the first wireless node to the controller, packets via the slots of the second set of one or more slots allocated to the second wireless node; and receive, by the second wireless node from the controller, a message including slot allocation or reallocation information for a second frame, including information indicating that all slots of the second set of one or more slots, which were previously allocated to the second wireless node, have been reallocated to the first wireless node to enable the first wireless node to retransmit to the controller, during the second frame, data for which there was a failed data transmission during the first frame.

An apparatus may include: at least one processor; and at least one memory including computer program code; the at least one memory and the computer program code configured to, with the at least one processor, cause the apparatus at least to: allocate, by a controller to each of a plurality of wireless nodes within a wireless network provided for a patient monitoring system, at least one initial slot for transmission of new data in a first frame and at least one retransmission slot for retransmission of data in one or more subsequent frames, wherein each frame includes a plurality of slots, wherein the wireless nodes include at least a first wireless node and a second wireless node, wherein the allocating includes allocating to the second wireless node at least a first retransmission slot for data retransmission in one or more frames subsequent to a first frame; determine, by the controller based on data transmissions performed during the first frame, that there is a failed data transmission from the first wireless node during the first frame; determine, by the controller based on data transmissions performed during the first frame, that the second wireless node does not need the at least the first retransmission slot that was allocated to the second wireless node for data retransmission for one or more frames subsequent to the first frame; and transmit, by the controller to the plurality of wireless nodes including at least the first wireless node and the second wireless node, a retransmission slot allocation message including information indicating that the at least the first retransmission slot that was allocated to the second wireless node for data retransmission has been allocated to the first wireless node for at least one frame subsequent to the first frame.

Various example embodiments of the controller or hub, and/or wireless nodes may, at least in part, be implemented by a computer or a processor, and may execute software or computer programs. A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
allocating, by a controller within a wireless network for a first frame, slots to a plurality of wireless nodes within a wireless network, wherein each of the plurality of wireless nodes has one or more allocated slots for transmission or retransmission of data at least for the first frame, and wherein each frame includes a plurality of slots;
determining, by the controller based on data transmissions performed during the first frame, that there is a failed data transmission from a first wireless node to the controller via at least one slot of a first set of one or more slots that were allocated to the first wireless node;
determining, by the controller based on data transmissions performed during the first frame, that data was received by the controller from a second wireless node via at least one slot of a second set of one or more slots allocated to the second wireless node; and
transmitting, by the controller to a plurality of wireless nodes including at least the first wireless node and the second wireless node, a message including slot allocation or reallocation information for the second frame, including information indicating that the at least one slot of the second set of one or more slots, which were allocated to the second wireless node, has been reallocated to the first wireless node to enable the first wireless node to retransmit to the controller, during the second frame, data for which there was a failed data transmission during the first frame, via the reallocated at least one slot.

2. The method of claim 1, wherein the determining, by the controller based on data transmissions performed during the first frame, that data was received by the controller from a second wireless node via at least one slot of a second set of one or more slots allocated to the second wireless node comprises:
determining, by the controller, that there was no failed data transmission from the second wireless node to the controller during the first frame.

3. The method of claim 2, wherein the transmitting comprises:
transmitting, by the controller, the message including slot allocation or reallocation information for the second frame, including information indicating that all slots of the second set of one or more slots, which were allocated to the second wireless node, have been reallocated to the first wireless node to enable the first wireless node to retransmit to the controller, during the second frame, data for which there was a failed data transmission during the first frame.

4. The method of claim 1, wherein:
each wireless node is connected to a sensor that collects patient data for transmission to the controller.

5. The method of claim 1, wherein the wireless network comprises a medical body area network in which patient data is sensed and/or collected from a patient and transmitted, via one or more of the wireless nodes, to the controller.

6. The method of claim 1, wherein the determining, by the controller based on data transmissions performed during the first frame, that there is the failed data transmission from the first wireless node to the controller via at least one slot of a first set of one or more slots that were allocated to the first wireless node comprises:
determining, by the controller based on data transmissions performed during the first frame, that there was no packet received by the controller from the first wireless node via at least one slot of a first set of one or more slots that were allocated to the first wireless node, wherein the first wireless node is enabled to transmit either a data packet or a null or empty packet on each slot of the first set of one or more slots allocated to the first wireless node.

7. The method of claim 1, wherein the determining, by the controller based on data transmissions performed during the first frame, that there is the failed data transmission from the first wireless node to the controller via at least one slot of a first set of one or more slots that were allocated to the first wireless node comprises:
receiving, by the controller from the first wireless node, control information indicating one or more slots, of the first set of one or more slots that were allocated to the first wireless node, for which data will be transmitted or was transmitted during the first frame;
determining, by the controller based on data transmissions performed during the first frame and the control information received by the controller from the first wireless node, that no data was received by the controller from the first wireless node via at least one slot for which the control information indicated that data was or will be transmitted during the first frame.

8. The method of claim 1, wherein a first subset of one or more slots are used by the wireless nodes for transmission of data, and a second subset of one or more slots are used by the wireless nodes for retransmission of data for which there was a failed data transmission to the controller.

9. The method of claim 1, wherein the message including slot allocation or reallocation information for the second frame, further includes information indicating a reallocation of an empty slot to the first wireless nod, wherein the empty slot was not allocated to any wireless nodes or used for transmission during the first frame, to enable the first wireless node to retransmit to the controller, during the second frame, data for which there was a failed data transmission during the first frame, via the reallocated empty slot.

10. A method comprising:
receiving, by a first wireless node from a controller within a wireless network, an allocation of a first set of one or more slots for transmission or retransmission of data at least for a first frame, and wherein each frame includes a plurality of slots;
transmitting, by the first wireless node to the controller, a packet via each of the slots of the first set of one or more slots allocated to the first wireless node; and
receiving, by the first wireless node from the controller, a message including slot allocation or reallocation information for a second frame, including information indicating that at least one slot of a second set of one or more slots, which were previously allocated to another wireless node, has been reallocated to the first wireless node to enable the first wireless node to retransmit to the controller, during the second frame, data for which there was a failed data transmission during the first frame.

11. The method of claim 10, wherein the transmitting, by the first wireless node to the controller, a packet via each of the slots of the first set of one or more slots allocated to the first wireless node comprises transmitting either a data packet, or a null or empty packet, via each of the slots of the first set of one or more slots allocated to the first wireless node.

12. The method of claim 10, further comprising:
determining, by the first wireless node, that there was a failed data transmission of a data packet during the first frame; and
retransmitting a data packet, associated with data or the data packet for which there was a failed transmission, during the second frame via the reallocated at least one slot that was reallocated to the first wireless node.

13. A method comprising:
receiving, by a second wireless node from a controller within a wireless network for a first, an allocation of a second set of one or more slots for transmission or retransmission of data at least for the first frame, and wherein each frame includes a plurality of slots;
transmitting, by the first wireless node to the controller, packets via the slots of the second set of one or more slots allocated to the second wireless node; and
receiving, by the second wireless node from the controller, a message including slot allocation or reallocation information for a second frame, including information indicating that all slots of the second set of one or more slots, which were previously allocated to the second wireless node, have been reallocated to the first wireless node to enable the first wireless node to retransmit to the controller, during the second frame, data for which there was a failed data transmission during the first frame.

14. A method comprising:
allocating, by a controller to each of a plurality of wireless nodes within a wireless network provided for a patient monitoring system, at least one initial slot for transmission of new data in a first frame and at least one retransmission slot for retransmission of data in one or more subsequent frames, wherein each frame includes a plurality of slots, wherein the wireless nodes include at least a first wireless node and a second wireless node, wherein the allocating includes allocating to the second wireless node at least a first retransmission slot for data retransmission in one or more frames subsequent to a first frame;
determining, by the controller based on data transmissions performed during the first frame, that there is a failed data transmission from the first wireless node during the first frame;
determining, by the controller based on data transmissions performed during the first frame, that the second wireless node does not need the at least the first retransmission slot that was allocated to the second wireless node for data retransmission for one or more frames subsequent to the first frame; and
transmitting, by the controller to the plurality of wireless nodes including at least the first wireless node and the second wireless node, a retransmission slot allocation message including information indicating that the at least the first retransmission slot that was allocated to the second wireless node for data retransmission has been allocated to the first wireless node for at least one frame subsequent to the first frame.

15. The method of claim 14, wherein determining, by the controller based on data transmissions performed during the first frame, that there is the failed data transmission from the first wireless node during the first frame comprises:
determining, by the controller based on data transmissions performed during the first frame, that there was no packet received by the controller from the first wireless node via at least one initial slot allocated to the first wireless node, wherein the first wireless node is enabled to transmit either a data packet or a null or empty packet on each initial slot allocated to the first wireless node.

16. The method of claim 14, wherein the retransmission slot allocation message is provided within a beacon packet or message that is transmitted at least one of the following: beginning of a frame, or end of a frame.
